(19) United States
(12) Patent Application Publication
(10) Pub. No.: US 2019/0385563 A1
(43) Pub. Date: Dec. 19, 2019

(54) DISPLAY DEVICE AND DRIVING METHOD THEREOF

(71) Applicant: SHARP KABUSHIKI KAISHA, Sakai City, Osaka (JP)

(72) Inventors: MASAHIRO HIROKANE, Sakai City, Osaka (JP); HIROKAZU FUJIMOTO, Sakai City, Osaka (JP)

(21) Appl. No.: 16/489,590

(22) PCT Filed: May 2, 2018
(86) PCT No.: PCT/JP2018/017497

§ 371 Date: Aug. 28, 2019

(30) Foreign Application Priority Data
May 12, 2017 (JP) 2017-095583

(51) Int. Cl. G09G 3/36

(52) U.S. Cl. CPC G09G 3/3696; G09G 2310/08; G09G 3/3688; G09G 3/3677

(57) ABSTRACT

In a display device having a display panel including a plurality of scanning lines, a plurality of data lines classified into a plurality of groups, and a plurality of pixel circuits, a scanning line drive circuit that drives the plurality of scanning lines, and a plurality of data line drive circuits, each driving the data lines in each group, the plurality of data line drive circuits apply voltages to the data lines in each group in accordance with a plurality of latch strobe signals that change at timings different from each other. The plurality of latch strobe signals are generated by delaying a base control signal by times different from each other. With this, a display device that suppresses noise imposed on a voltage of the scanning line when a voltage of the data line changes is provided.

### TECHNICAL FIELD

The present invention relates to an active matrix type display device and a driving method thereof.

### BACKGROUND ART

An active matrix type display device includes a display panel, a scanning line drive circuit, a data line drive circuit, and the like. A plurality of scanning lines, a plurality of data lines, and a plurality of pixel circuits arranged two-dimensionally are formed on the display panel. The scanning line drive circuit is also called a gate driver, and the data line drive circuit is also called a source driver.

FIG. 10 is a circuit diagram of a pixel circuit formed on a liquid crystal panel. A pixel circuit 90 shown in FIG. 10 includes a thin film transistor (hereinafter referred to as TFT) 91, a liquid crystal capacitor 92, and an auxiliary capacitor 93. A gate terminal of the TFT 91 is connected to a scanning line Gi, and a source terminal of the TFT 91 is connected to a data line Sj. A drain terminal of the TFT 91 is connected to one electrode of the liquid crystal capacitor 92 and one electrode of the auxiliary capacitor 93. A common voltage Vcom is applied to the other electrode of the liquid crystal capacitor 92, and an auxiliary capacitor voltage Vcs is applied to the other electrode of the auxiliary capacitor 93. The pixel circuit 90 has a gate-source capacitor 94 between the gate terminal and the source terminal of the TFT 91.

Generally, a configuration of the data line drive circuit is more complicated than that of the scanning line drive circuit. Thus, even when the scanning lines can be driven using one scanning line drive circuit, a plurality of data line drive circuits may be required to drive the data lines. In the following, display devices having a plurality of data line drive circuits will be considered.

As a prior art, Patent Document 1 describes a display device that supplies a plurality of clock pulses and a plurality of start pulses having shifted phases, to a plurality of data line drive circuits. According to the display device described in Patent Document 1, since the plurality of data line drive circuits perform sampling on image data at different timings, it is possible to take in the image data at a high frequency and to prevent degradation of image quality.

### PRIOR ART DOCUMENT

### Patent Document

[Patent Document 1] Japanese Laid-Open Patent Publication No. 2009-31751

### SUMMARY OF THE INVENTION

### Problems to be Solved by the Invention

In the pixel circuit 90 shown in FIG. 10, the scanning line Gi and the data line Sj are connected via the gate-source capacitor 94, thus, when a voltage of the data line Sj (voltage applied to the data line Sj by the data line drive circuit) changes, a voltage of the scanning line Gi also changes due to its effect. Especially, when an amount of change in the voltage of the data line Sj is large, an amount of change in the voltage of the scanning line Gi becomes unignorably large, and noise is imposed on the voltage of the scanning line Gi. When the noise is large, the scanning line drive circuit may malfunction and a liquid crystal display device may not display an image correctly.

According to the display device described in Patent Document 1, it is possible for each data line drive circuit to take in the image data at a high frequency, by shifting phases between the plurality of clock pulses and between the plurality of start pulses. However, this display device cannot solve the above problem.

Therefore, providing a display device that suppresses noise imposed on a voltage of a scanning line when a voltage of a data line changes is taken as a problem.

### MEANS FOR SOLVING THE PROBLEMS

The above problems can be solved, for example, by a display device having: a display panel including a plurality of scanning lines, a plurality of data lines classified into a plurality of groups, and a plurality of pixel circuits; a scanning line drive circuit configured to drive the plurality of scanning lines; and a plurality of data line drive circuits, each configured to drive the data lines in each group, wherein the plurality of data line drive circuits is configured to apply voltages to the data lines in each group in accordance with a plurality of latch strobe signals that change at timings different from each other.

The above problem can also be solved, by a driving method of a display device having a display panel including a plurality of scanning lines, a plurality of data lines classified into a plurality of groups, and a plurality of pixel circuits, the method including: driving the plurality of scanning lines using a scanning line drive circuit; and driving the data lines in each group using a plurality of data line drive circuits, wherein in driving the data lines, voltages are applied to the data lines in each group in accordance with a plurality of latch strobe signals that change at timings different from each other, using the plurality of data line drive circuits.

### EFFECTS OF THE INVENTION

According to the display device and the driving method described above, since the plurality of data line drive circuits apply voltages to the data lines in each group in accordance with the plurality of latch strobe signals that change at timings different from each other, change timings of voltages of the data lines are different with respect to each group. Thus, noise imposed on a voltage of the scanning line when the voltage of the data line changes can be reduced to equal to or less than 1/(the number of the data line drive circuits). Therefore, it is possible to prevent from erroneously writing the voltage of the data line to the pixel circuit and to prevent a disturbance of a display image, and it is possible to prevent a malfunction of the scanning line drive circuit and to display an image correctly.

### BRIEF DESCRIPTION OF THE DRAWINGS

FIG. 1 is a block diagram showing a configuration of a liquid crystal display device according to a first embodiment.

FIG. 2 is a diagram showing details of a liquid crystal panel shown in FIG. 1.

FIG. 3 is a diagram showing a configuration of a timing control circuit shown in FIG. 1.

FIG. 4 is a diagram showing another configuration of the timing control circuit shown in FIG. 1.

FIG. 5 is a signal waveform diagram of the liquid crystal display device shown in FIG. 1.

FIG. 6 is a diagram showing positions in the liquid crystal panel shown in FIG. 1.

FIG. 7 is a signal waveform diagram of a liquid crystal display device according to a comparative example.

FIG. 8 is a signal waveform diagram of the liquid crystal display device shown in FIG. 1.

FIG. 9 is a block diagram showing a configuration of a liquid crystal display device according to a second embodiment.

FIG. 10 is a circuit diagram of a pixel circuit formed on a liquid crystal panel.

### MODES FOR CARRYING OUT THE INVENTION

### First Embodiment

FIG. 1 is a block diagram showing a configuration of a liquid crystal display device according to a first embodiment. A liquid crystal display device 10 shown in FIG. 1 includes a liquid crystal panel 11, a timing control circuit 12, a scanning line drive circuit 13, and four data line drive circuits 14a to 14d. Hereinafter, a horizontal direction of the drawings is referred to as a row direction, and a vertical direction of the drawings is referred to as a column direction. It is assumed that m is an integer equal to or more than 2, n is a multiple of 4, and i and k are integers not less than 1 and not more than m.

The timing control circuit 12, the scanning line drive circuit 13, and the data line drive circuits 14a to 14d are respectively included in one semiconductor chip. The scanning line drive circuit 13 is provided along one side (left side in the drawings) extending in the column direction of the liquid crystal panel 11. The data line drive circuits 14a to 14d are provided along another side (upper side in the drawings) extending in the row direction of the liquid crystal panel 11.

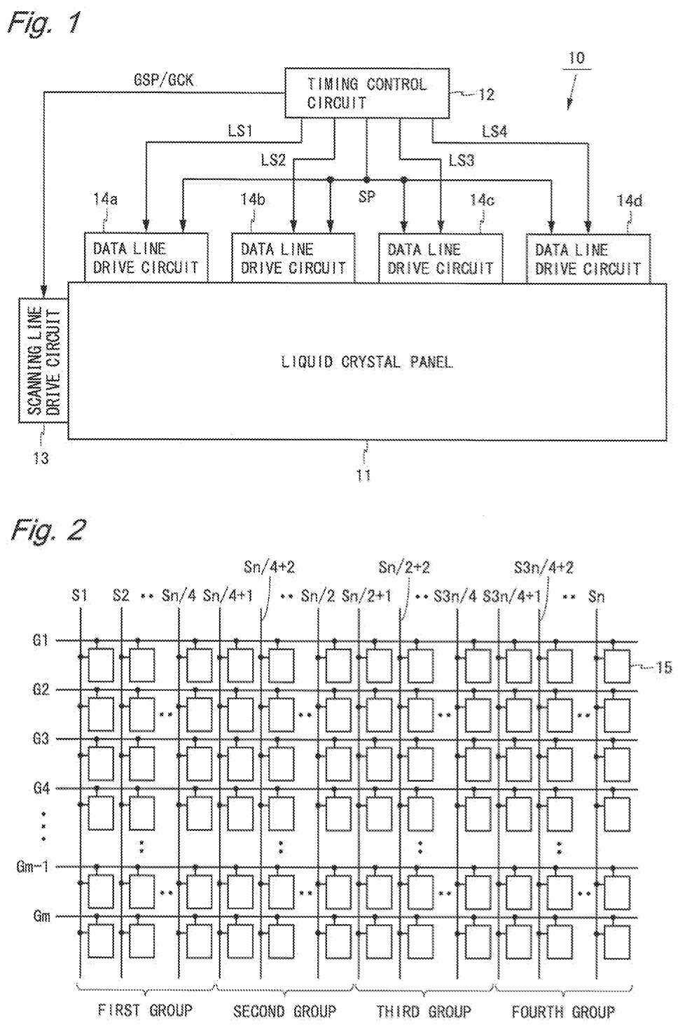

FIG. 2 is a diagram showing details of the liquid crystal panel 11. As shown in FIG. 2, the liquid crystal panel 11 includes m scanning lines G1 to Gm, n data lines S1 to Sn, and (m×n) pixel circuits 15. The scanning lines G1 to Gm extend in the row direction, and are arranged in parallel to each other. The data lines S1 to Sn extend in the column direction, and are arranged in parallel to each other so as to intersect with the scanning lines G1 to Gm perpendicularly. The scanning lines G1 to Gm and the data lines S1 to Sn intersect at (m×n) positions. The (m×n) pixel circuits 15 are provided corresponding to intersections of the scanning lines G1 to Gm and the data lines S1 to Sn.

The timing control circuit 12 outputs a control signal to the scanning line drive circuit 13, and outputs a control signal and a video signal (not shown) to the data line drive circuits 14a to 14d. The control signal output to the scanning line drive circuit 13 includes a gate start pulse GSP and a gate clock GCK. The scanning line drive circuit 13 drives the scanning lines G1 to Gm based on these control signals.

The data line drive circuits 14a to 14d drive the data lines S1 to Sn based on the control signal and the video signal. The control signal output to the data line drive circuits 14a to 14d include a start pulse SP and four latch strobe signals LS1 to LS4. The start pulse SP is supplied to all of the data line drive circuits 14a to 14d. The latch strobe signals LS1 to LS4 are respectively supplied to the data line drive circuits 14a to 14d.

The data lines S1 to Sn are classified into four groups (hereinafter referred to as first to fourth groups) in an arrangement order. The data line drive circuits 14a to 14d are respectively corresponded to the first to fourth groups and drive the data lines in the corresponding group. Specifically, the data line drive circuit 14a drives the data lines in the first group based on the start pulse SP, the latch strobe signal LS1, and the video signal. The data line drive circuit 14b drives the data lines in the second group based on the start pulse SP, the latch strobe signal LS2, and the video signal. The data line drive circuit 14c drives the data lines in the third group based on the start pulse SP, the latch strobe signal LS3, and the video signal. The data line drive circuit 14d drives the data lines in the fourth group based on the start pulse SP, the latch strobe signal LS4, and the video signal.

The latch strobe signals LS1 to LS4 respectively indicate timings at which the data line drive circuits 14a to 14d apply voltages to the data lines in each group. The data line drive circuit 14a applies (n/4) voltages to the data lines in the first group when the latch strobe signal LS1 changes from high-level to low-level. The data line drive circuit 14b applies (n/4) voltages to the data lines in the second group when the latch strobe signal LS2 changes from high-level to low-level. The data line drive circuit 14c applies (n/4) voltages to the data lines in the third group when the latch strobe signal LS3 changes from high-level to low-level. The data line drive circuit 14d applies (n/4) voltages to the data lines in the fourth group when the latch strobe signal LS4 changes from high-level to low-level.

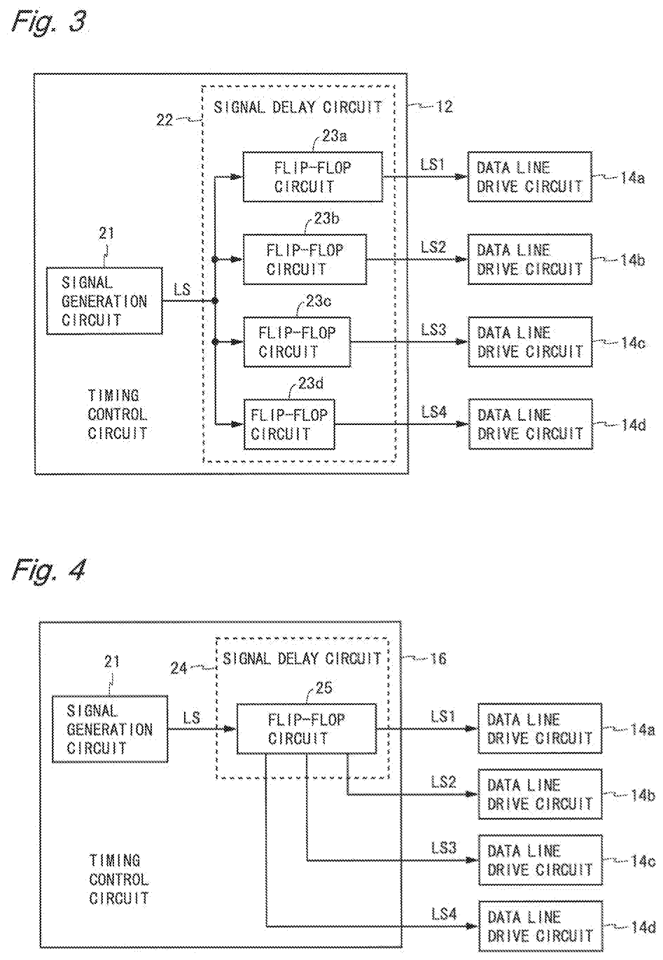

FIG. 3 is a diagram showing a configuration of the timing control circuit 12. As shown in FIG. 3, the timing control circuit 12 includes a signal generation circuit 21 and a signal delay circuit 22. The signal generation circuit 21 generates a latch strobe signal LS and other control signals (not shown). The latch strobe signal LS is a control signal that is a base of the latch strobe signals LS1 to LS4, and becomes high-level once in one line period (one horizontal period) for a predetermined time. The signal delay circuit 22 includes four flip-flop circuits 23a to 23d. The latch strobe signal LS is input to the flip-flop circuits 23a to 23d.

The flip-flop circuits 23a to 23d have a configuration in which a plurality of flip-flops is connected in multi-stage. The numbers of the flip-flops included in the flip-flop circuits 23a to 23d decrease in an order of the flip-flop circuit 23a, the flip-flop circuit 23b, the flip-flop circuit 23c, and the flip-flop circuit 23d. Thus, delay times of the flip-flop circuits 23a to 23d become shorter in the same order.

Output signals of the flip-flop circuits 23a to 23d are respectively output to the data line drive circuits 14a to 14d as the latch strobe signals LS1 to LS4. The latch strobe signals LS1 to LS4 change at timings different from each other. The latch strobe signals LS1 to LS4 change in an order of LS4, LS3, LS2, and LS1. When the first to fourth groups are arranged in an order of closeness to the scanning line drive circuit 13, the groups are arranged in the order of the first group, the second group, the third group, and the fourth group.

In this manner, the data line drive circuits 14a to 14d apply voltages to the data lines in each group in accordance with the latch strobe signals LS1 to LS4 that change at timings different from each other. The signal generation circuit 21 generates the control signal that is the base of the latch strobe signals LS1 to LS4, and the signal delay circuit 22 delays the control signal by times different from each other to generate the latch strobe signals LS1 to LS4. The signal generation circuit 21 and the signal delay circuit 22 are included in a same semiconductor chip. The scanning line drive circuit 13 is provided along one side of the liquid crystal panel 11, and among the latch strobe signals LS1 to LS4, a latch strobe signal corresponding to a group changes at an earlier timing, as the group is more apart from the scanning line drive circuit 13.

Note that the liquid crystal display device 10 may include a timing control circuit 16 shown in FIG. 4 in place of the timing control circuit 12. The timing control circuit 16 shown in FIG. 4 includes the signal generation circuit 21 and a signal delay circuit 24 having one flip-flop circuit 25. The latch strobe signal LS is input to the flip-flop circuit 25. An output signal of the flip-flop in a final stage of the flip-flop circuit 25 is output to the data line drive circuit 14a as the latch strobe signal LS1. Output signals of non-final stages of the flip-flop circuit 25 are output to the data line drive circuits 14b to 14d as the latch strobe signals LS2 to LS4 in an order of closeness to the final stage. Also in the timing control circuit 12 shown in FIG. 4, among the latch strobe signals LS1 to LS4, a latch strobe signal corresponding to a group changes at an earlier timing, as the group is more apart from the scanning line drive circuit 13.

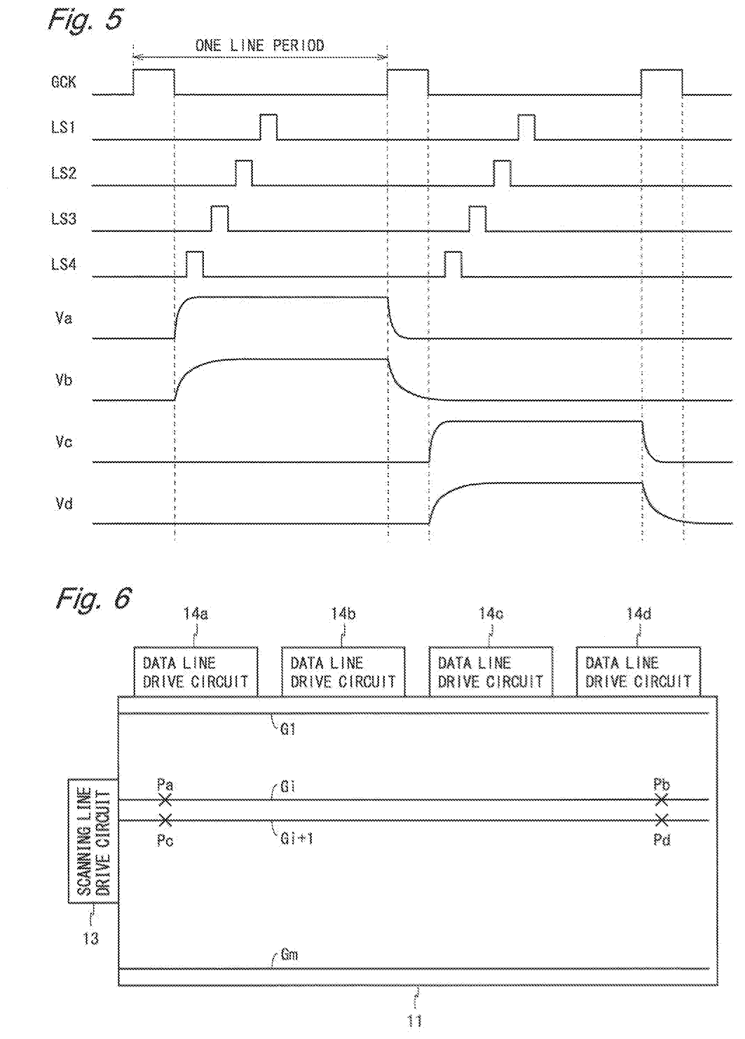

FIG. 5 is a signal waveform diagram of the liquid crystal display device 10. As shown in FIG. 5, the gate clock GCK becomes high-level once in one line period for a predetermined time. The latch strobe signals LS1 to LS4 become high-level for a predetermined time (becomes high-level once and then becomes low-level) at timings different from each other, after the gate clock GCK becomes high-level. The latch strobe signals LS1 to LS4 change in the order of LS4, LS3, LS2, and LS1.

FIG. 5 describes voltages Va, Vb of the scanning line Gi at points Pa, Pb shown in FIG. 6 and voltages Vc, vd of a scanning line Gi+1 at points Pc, Pd shown in FIG. 6. The points Pa, Pc are located close to the scanning line drive circuit 13, and the points Pb, Pd are located apart from the scanning line drive circuit 13. The larger a distance from the scanning line drive circuit 13 is, the larger dullness of a voltage waveform of the scanning line is. Thus, dullness of the voltage waveform of the scanning line Gi is small at the point Pa, but becomes larger at the point Pb than at the point Pa. When the dullness of the voltage waveform of the scanning line is large, an on-time of a TFT (not shown) in the pixel circuit 15 becomes short, and a liquid crystal capacitor (not shown) in the pixel circuit 15 may not be charged to a desired level. Such shortage of charging is more likely to occur in the pixel circuits 15 apart from the scanning line drive circuit 13 than in the pixel circuits 15 close to the scanning line drive circuit 13.

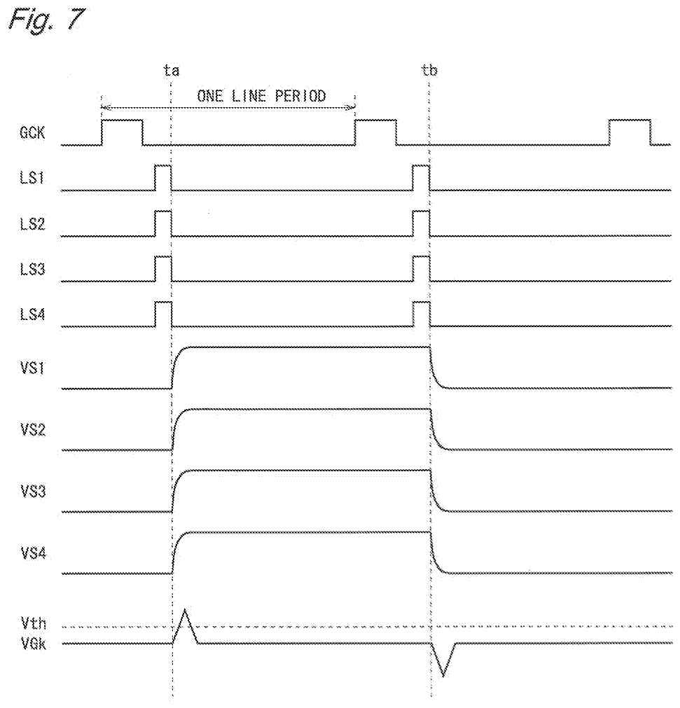

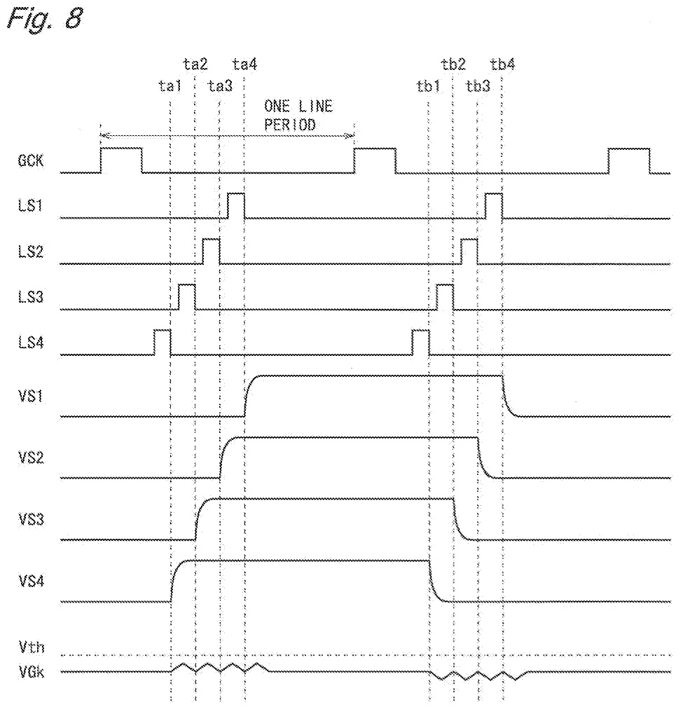

In the following, effects of the liquid crystal display device 10 are explained, when compared with a liquid crystal display device (hereinafter referred to as a liquid crystal display device according to a comparative example) that outputs four latch strobe signals LS1 to LS4 at a same timing to four data line drive circuits. FIG. 7 is a signal waveform diagram of the liquid crystal display device according to the comparative example. FIG. 8 is a signal waveform diagram of the liquid crystal display device 10. In FIGS. 7 and 8, VS1 to VS4 respectively indicate voltages of certain data lines in the first to fourth groups, and VGk indicates a voltage of a k-th scanning line Gk which is not selected.

In the liquid crystal display device according to the comparative example (FIG. 7), the latch strobe signals LS1 to LS4 change from high-level to low-level at same timings at times ta, tb. Thus, the voltages VS1 to VS4 of the data lines in the first to fourth groups start to change at the same timing at the times ta, tb. However, as described with reference to FIG. 10, since the TFT in the pixel circuit has a gate-source capacitor, when a voltage of the data line changes, a voltage of the scanning line also changes, and noise is imposed on the voltage of the scanning line. In the liquid crystal display device according to the comparative example, since all of the voltages of the data lines S1 to Sn change at the same timing, large noise is imposed on the voltage VGk of the scanning line Gk.

In this example, including the voltages VS1 to VS4 of the data lines in the first to fourth groups, the voltages of the data lines S1 to Sn start to change from low-level to high-level at the time ta and start to change from high-level to low-level at the time tb. Thus, on the voltage VGk of the scanning line Gk, positive noise is imposed near the time ta, and negative noise is imposed near the time tb. When the positive noise is large and the voltage VGk of the scanning line Gk exceeds a threshold voltage Vth of the TFT in the pixel circuit, the voltage of the data line may be erroneously written to the pixel circuit, and disturbance may occur in a display image. Furthermore, when the positive or negative noise is large, the scanning line drive circuit may malfunction, and an image may not be displayed correctly.

On the contrary, in the liquid crystal display device 10 (FIG. 8), the latch strobe signals LS1 to LS4 change from high-level to low-level at different timings at times ta1 to ta4 and tb1 to tb4. Thus, the voltages VS1 to VS4 of the data lines in the first to fourth groups start to change at the different timings at the times ta1 to ta4 and tb1 to tb4. Therefore, noise imposed on the voltage VGk of the scanning line Gk when the voltages of the data lines S1 to Sn change is reduced to equal to or less than ¼ of that in the liquid crystal display device according to the comparative example. Therefore, according to the liquid crystal display device 10, it is possible to prevent from erroneously writing the voltages of the data lines S1 to Sn to the pixel circuit 15, and to prevent disturbance of the display image. Furthermore, it is possible to prevent malfunction of the scanning line drive circuit 13 and to display an image correctly.

As stated above, in the pixel circuit 15 apart from the scanning line drive circuit 13, shortage of charging is more likely to occur than in the pixel circuit 15 close to the scanning line drive circuit 13. Taking this point into consideration, in the liquid crystal display device 10, among the latch strobe signals LS1 to LS4, a latch strobe signal corresponding to a group changes earlier, as the group is more apart from the scanning line drive circuit 13. Thus, in the pixel circuits 15 apart from the scanning line drive circuit 13, the voltage of the data line starts to change at a timing earlier than in the pixel circuits 15 close to the scanning line drive circuit 13. With this, shortage of charging in the pixel circuit 15 can be reduced.

As described above, according to the liquid crystal display device 10 according to the present embodiment, since the plurality of data line drive circuits 14a to 14d apply voltages to the data lines in each group in accordance with the plurality of latch strobe signals LS1 to LS4 that change at timings different from each other, change timings of the voltages of the data lines S1 to Sn are different with respect to each group. Thus, it is possible to reduce noise imposed on the voltage of the scanning line when the voltages of the data lines S1 to Sn change, to equal to or less than 1/(the number of the data line drive circuits 14a to 14d) (equal to or less than ¼). Therefore, it is possible to prevent from erroneously writing the voltages of the data lines S1 to Sn to the pixel circuit 15 and to prevent the disturbance of the display image, and it is possible to prevent the malfunction of the scanning line drive circuit 13 and to display the image correctly. Furthermore, since among the plurality of latch strobe signals LS1 to LS4, a latch strobe signal corresponding to a group changes earlier, as the group is more apart from the scanning line drive circuit 13, shortage of charging in the pixel circuit 15 can be reduced.

### Second Embodiment

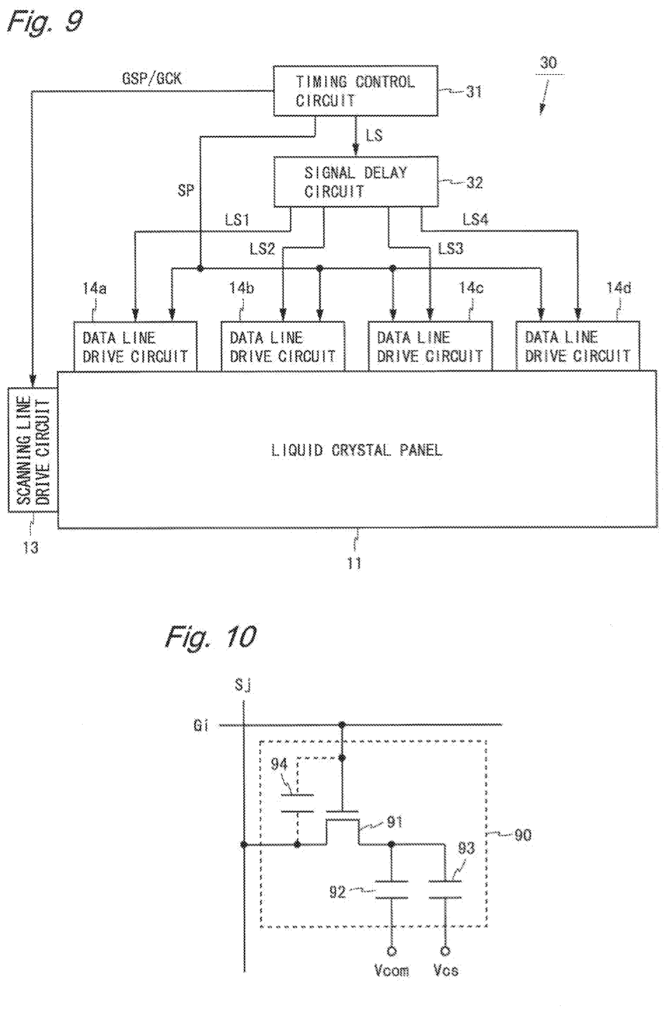

FIG. 9 is a block diagram showing a configuration of a liquid crystal display device according to a second embodiment. A liquid crystal display device 30 shown in FIG. 9 is obtained based on the liquid crystal display device 10 according to the first embodiment, by replacing the timing control circuit 12 with a timing control circuit 31 and a signal delay circuit 32. The timing control circuit 31, the signal delay circuit 32, the scanning line drive circuit 13, and the data line drive circuits 14a to 14d are respectively included in one semiconductor chip. Among components of this embodiment, as for the same components as those in the first embodiment, the same reference symbols are provided and their description is omitted.

The timing control circuit 31 is obtained by removing the signal delay circuit 22 from the timing control circuit 12 (FIG. 3). The signal delay circuit 32 is the signal delay circuit 22 removed from the timing control circuit 12. In this manner, the liquid crystal display device 30 has a configuration in which the signal delay circuit is provided outside the timing control circuit in the liquid crystal display device 10 according to the first embodiment. The signal generation circuit 21 and the signal delay circuit 32 are included in different semiconductor chips. According to the liquid crystal display device 30 according to the present embodiment, since an existing timing control circuit can be used, it is not necessary to newly design a timing control circuit.

Although liquid crystal display devices including four data line drive circuits are described so far, the number of data line drive circuits included in the liquid crystal display device may be arbitrary as long as it is equal to or more than 2. Furthermore, although liquid crystal display devices including one scanning line drive circuit are described so far, the number of scanning line drive circuits included in the liquid crystal display device may be equal to or more than 2. Furthermore, although the signal delay circuit is configured using flip-flops, the signal delay circuit may have any configuration as long as it has a function of delaying a signal. Furthermore, display devices other than liquid crystal display devices can be configured in a manner similar to each embodiment.

This application claims a priority based on Japanese Patent Application No. 2017-95583 filed on May 12, 2017, and entitled “Display Device And Driving Method Thereof”, which is incorporated herein by reference in its entirety.

### DESCRIPTION OF REFERENCE CHARACTERS

10, 30: LIQUID CRYSTAL DISPLAY DEVICE

11: LIQUID CRYSTAL PANEL

12, 16, 31: TIMING CONTROL CIRCUIT

13: SCANNING LINE DRIVE CIRCUIT

14: DATA LINE DRIVE CIRCUIT

15: PIXEL CIRCUIT

21: SIGNAL GENERATION CIRCUIT

22, 24, 32: SIGNAL DELAY CIRCUIT

23, 25: FLIP-FLOP CIRCUIT

1. A display device comprising:
a display panel including a plurality of scanning lines, a plurality of data lines classified into a plurality of groups, and a plurality of pixel circuits;
a scanning line drive circuit configured to drive the plurality of scanning lines; and
a plurality of data line drive circuits, each configured to drive the data lines in each group, wherein
the plurality of data line drive circuits is configured to apply voltages to the data lines in each group in accordance with a plurality of latch strobe signals that change at timings different from each other.

2. The display device according to claim 1, further comprising:
a signal generation circuit configured to generate a control signal that is a base of the plurality of latch strobe signals; and
a signal delay circuit configured to generate the plurality of latch strobe signals by delaying the control signal by times different from each other.

3. The display device according to claim 2, wherein the plurality of data lines is classified into the plurality of groups in an arrangement order.

4. The display device according to claim 3, wherein the scanning line drive circuit is provided along one side of the display panel, and
among the plurality of latch strobe signals, a latch strobe signal corresponding to a group changes at an earlier timing, as the group is more apart from the scanning line drive circuit.

5. The display device according to claim 2, wherein the signal generation circuit and the signal delay circuit are included in a same semiconductor chip.

6. The display device according to claim 2, wherein the signal generation circuit and the signal delay circuit are included in different semiconductor chips.

7. The display device according to claim 1, wherein the display panel is a liquid crystal panel.

8. A driving method of a display device having a display panel including a plurality of scanning lines, a plurality of data lines classified into a plurality of groups, and a plurality of pixel circuits, the method comprising:
driving the plurality of scanning lines using a scanning line drive circuit; and
driving the data lines in each group using a plurality of data line drive circuits, wherein
in driving the data lines, voltages are applied to the data lines in each group in accordance with a plurality of latch strobe signals that change at timings different from each other, using the plurality of data line drive circuits.
